(19) United States
(12) Patent Application Publication
(10) Pub. No.: US 2016/0066307 A1
(43) Pub. Date: Mar. 3, 2016

(54) MIMO COMMUNICATION METHOD AND SYSTEM

(71) Applicant: Spreadtrum Communications (Shanghai) Co., Ltd., Zhangjiang (CN)

(72) Inventors: Wentao HUANG, Zhangjiang (CN); Shanyi XIE, Zhangjiang (CN); Guotao ZHAO, Zhangjiang (CN)

(21) Appl. No.: 14/684,879

(22) Filed: Apr. 13, 2015

(30) Foreign Application Priority Data
Aug. 30, 2014 (CN) 201410439769.3

(51) Int. Cl. H04W 72/04; H04L 5/00

(52) U.S. Cl. CPC H04W 72/0406; H04L 5/0023; H04W 88/06

(57) ABSTRACT

A MIMO communication method and a MIMO system are provided. The method includes: a base band unit sending a control signal to a first RFFE unit or a second RFFE unit; based on the control signal, the first RFFE unit or the second RFFE unit implementing a processing to a RF signal transmitted from the RF transceiver unit; and a first antenna coupled to the first RFFE unit or a second antenna coupled to the second RFFE unit transmitting the RF signal which has been subjected to the processing. One RF transceiver unit is used to transmit signals in two communication modes, such that the number of the RF transceiver units in the MIMO system can be reduced, which means less system resource will be occupied.

### CROSS-REFERENCE TO RELATED APPLICATIONS

The present invention claims priority under 35 U.S.C. §119 to Chinese Application No. 201410439769.3 filed Aug. 30, 2014, the entire content of which is incorporated herein by reference.

### FIELD OF THE DISCLOSURE

The present disclosure generally relates to communication technology, and more particularly, to a MIMO communication method and a MIMO system.

### BACKGROUND OF THE DISCLOSURE

With an increasing demand for high quality communication with large capacity, various communication technologies are optimized and new techniques are introduced to update existing communication standards. In such a way, data rate of mobile communication can be increased to meet the requirements of mobile communication users.

Multiple-Input Multiple-Output (MIMO) is an essential one of the developing communication techniques. In a MIMO system, multiple independent spatial streams between multiple antennas are used to transmit data, so theoretically channel capacity and data rate shall be multiplied. Since MIMO has such a direct multiplication effect, it has been widely applied in the mainstream of communication technology, including 802.11n (and following protocols) of 802.11 standard family for Wireless Local Area Networks (WLAN) system, as well as Long Term Evolution (LTE) standard for cellular communication.

Besides MIMO, Orthogonal Frequency Division Multiplexing (OFDM) is also introduced as physical resource multiplex scheme in 802.11n standard and LTE standard, in order to flexibly schedule wireless spectrum resources and get rid of severe inter-symbol interference (ISI) which is unavoidable in high-symbol-rate data transmission. OFDM distributes a single high-symbol-rate data stream over several synchronous low-symbol-rate data streams, which is modulated to several corresponding orthogonal carriers, called sub-carrier. MIMO technology and OFDM technology have specific requirements for Radio Frequency (RF) units.

To implement MIMO in a mobile terminal, it is not only required to dispose multiple independent antennas, but also urged to provide multiple independent RF units, including RF transceivers units and RF Front End (RFFE) units, each of which is assigned to support the transmission and receive in one of the multiple spatial streams. As a result, more RF units are needed. In existing applications, if a mobile terminal is required to implement MIMO for both WLAN and LTE, two sets of RF units are needed to respectively support MIMO for WLAN and MIMO for LTE, respectively. For example, to support a 8*8 MIMO system, the mobile terminal needs to be configured with 8 WLAN-compatible RF units and another 8 LTE-compatible RF units. A relatively large number of RF units may occupy too much system resource, such as the amount of power capacity, increase the complexity of device construction configuration and complexity of PCB layout, and also raise the total cost.

### SUMMARY

Embodiments provide a MIMO communication method and a MIMO system, which can reduce the number of RF transceiver units used and occupancy for system resource by sharing the same RF transceiver unit between two communication modes.

According to one embodiment, a MIMO communication method is provided, including:
a base band unit sending a control signal to a first RFFE unit or a second RFFE unit, where the control signal is used to control the first RFFE unit or the second RFFE unit to implement post processing to a RF signal transmitted from a RF transceiver unit which is coupled to both the first RFFE unit and the second RFFE unit;
based on the control signal, the first RFFE unit or the second RFFE unit implementing the post processing to the RF signal transmitted from the RF transceiver unit; and
a first antenna coupled to the first RFFE unit or a second antenna coupled to the second RFFE unit transmitting the RF signal which has been subjected to the post processing.

Optionally, the first RFFE unit is a RFFE unit for processing WLAN signals, and the second RFFE unit is a RFFE unit for processing LTE signals.

Optionally, the method further includes: processing a signal received by the first antenna or the second antenna to obtain information contained in the signal; and generating the control signal based on the information contained in the signal.

Optionally, the control signal is generated based on an instruction generated by the base band unit, and the instruction includes transmitting a WLAN signal or transmitting a LTE signal.

According to one embodiment, a MIMO communication method is provided, including:
using a first antenna to receive a signal in a first communication mode;
using a second antenna to receive a signal in a second communication mode;
using a first RFFE unit to preprocess the signal in the first communication mode to obtain a first RF signal;
using a second RFFE unit to preprocess the signal in the second communication mode to obtain a second RF signal; and
using a single RF transceiver unit to implement RF processing to both the first RF signal and the second RF signal.

Optionally, the first communication mode is WLAN mode, and the second communication mode is LTE mode.

According to one embodiment, a MIMO system is provided, including a base band unit, a RF transceiver unit, a first RFFE unit, a second RFFE unit, a first antenna, and a second antenna,
wherein the base band unit is adapted for sending a control signal to the first RFFE unit or the second RFFE unit, where the control signal is used to control the first RFFE unit or the second RFFE unit to implement a post processing to a RF signal transmitted from the RF transceiver unit,
wherein the RF transceiver unit is coupled to the base band unit and adapted for processing a base band signal transmitted from the base band unit to obtain the RF signal,
wherein the first RFFE unit is coupled to the RF transceiver unit and adapted for implementing a first post processing to the RF signal based on the control signal to obtain a first transmitting signal,
wherein the second RFFE unit is coupled to the RF transceiver unit and adapted for implementing a second post processing to the RF signal based on the control signal to obtain a second transmitting signal,
wherein the first antenna is coupled to the first RFFE unit and adapted for transmitting the first transmitting signal, and
wherein the second antenna is coupled to the second RFFE unit and adapted for transmitting the second transmitting signal.

Optionally, the first transmitting signal is a WLAN signal, and the second transmitting signal is a LTE signal.

Optionally, the base band unit is further adapted for processing a signal received by the first antenna or the second antenna to obtain information contained in the signal, and generating the control signal based on the information contained in the signal.

Optionally, the base band unit is further adapted for generating an instruction which includes transmitting a WLAN signal or transmitting a LTE signal, and generating the control signal based on the instruction.

According to one embodiment, a MIMO system is provided, including:
a first antenna adapted for receiving a signal in a first communication;
a second antenna adapted for receiving a signal in a second communication mode;
a first RFFE unit, coupled to the first antenna and adapted for preprocessing the signal in the first communication mode to obtain a first RF signal;
a second RFFE unit, coupled to the second antenna and adapted for preprocessing the signal in the second communication mode to obtain a second RF signal; and
a RF transceiver unit, coupled to both the first RFFE unit and the second RFFE unit, and adapted for implementing RF processing to both the first RF signal and the second RF signal.

Optionally, the first communication mode is WLAN mode, and the second communication mode is LTE mode.

Embodiments of the present disclosure have following advantages.

One RF transceiver unit is used to transmit signals in two communication modes, such that the number of the RF transceiver units in the MIMO system can be reduced, which means less system resource will be occupied.

Further, the two different communication modes are WLAN and LTE. Based on the control signal transmitted from the base band unit, a suitable RFFE unit can be selected to process to a WLAN signal or a LTE signal. Then a suitable antenna can be selected to send the corresponding signal. Therefore, interference raised by communicating signals in two different communication modes in the same RF transceiver route can be avoided.

### BRIEF DESCRIPTION OF THE DRAWINGS

FIG. 1 schematically illustrates a flow chart of a MIMO communication method according to one embodiment of the present disclosure;

FIG. 2 schematically illustrates a circuit structure inside of a MIMO system according to one embodiment of the present disclosure;

FIG. 3 schematically illustrates a block diagram of a MIMO system according to one embodiment of the present disclosure; and

FIG. 4 schematically illustrates a block diagram of a MIMO system according to one embodiment of the present disclosure

### DETAILED DESCRIPTION OF THE DISCLOSURE

As described in background, in a mobile terminal, there are required to dispose a relatively large number of RF units to respectively support MIMO applications in both WLAN communication and LTE communication. As a result, system resource may be overly occupied by the RF units.

Since both LTE communication and WLAN communication support MIMO, and RF transceiver units used in WLAN communication and LTE communication are both basically RF signal up-convertors and down-convertors, which are capable of processing wide-band signals such as OFDM signals, it could be understood that the RF transceiver units used in WLAN communication and LTE communication share substantially the same specific structures, especially for the mixers thereof. Besides, operating frequencies for LTE mode and WLAN mode are close to each other. In conclusion, WLAN communication and LTE communication have similar requirements for their corresponding RF transceiver units. Therefore, RF transceiver units may be shared for implementing both WLAN and LTE, so as to occupy less system resource.

In order to clarify the objects, characteristics and advantages of the disclosure, embodiments of the disclosure will be interpreted in detail in combination with accompanied drawings.

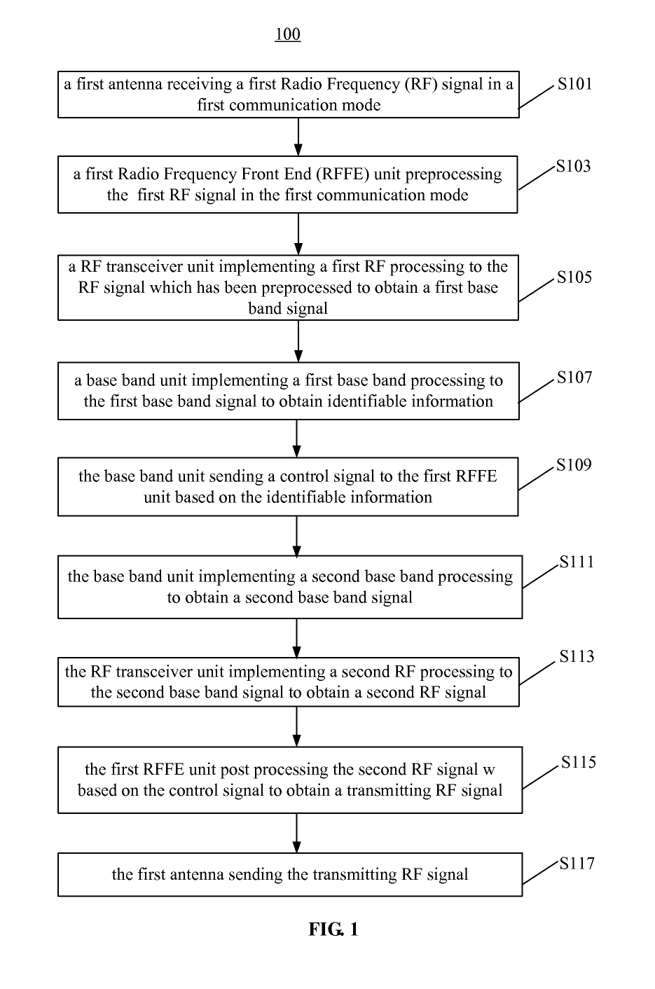

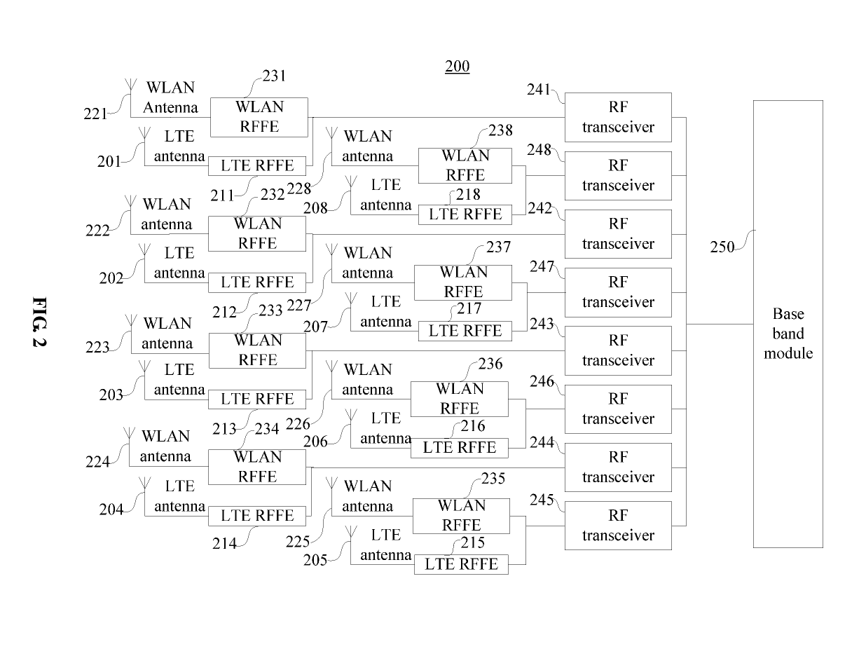

Referring to FIG. 1, which schematically illustrates a flow chart of a MIMO communication method 100 according to one embodiment of the present disclosure, the method may include:

Step S101, a first antenna receiving a first Radio Frequency (RF) signal in a first communication mode;

Step S103, a first Radio Frequency Front End (RFFE) unit preprocessing the first RF signal in the first communication mode;

Step S105, a RF transceiver unit implementing a first RF processing to the RF signal which has been preprocessed to obtain a first base band signal;

Step S107, a base band unit implementing a first base band processing to the first base band signal to obtain identifiable information;

Step S109, the base band unit sending a control signal to the first RFFE unit based on the identifiable information;

Step S111, the base band unit implementing a second base band processing to obtain a second base band signal;

Step S113, the RF transceiver unit implementing a second RF processing to the second base band signal to obtain a second RF signal;

Step S115, the first RFFE unit post processing the second RF signal based on the control signal to obtain a transmitting RF signal; and

Step S117, the first antenna sending the transmitting RF signal.

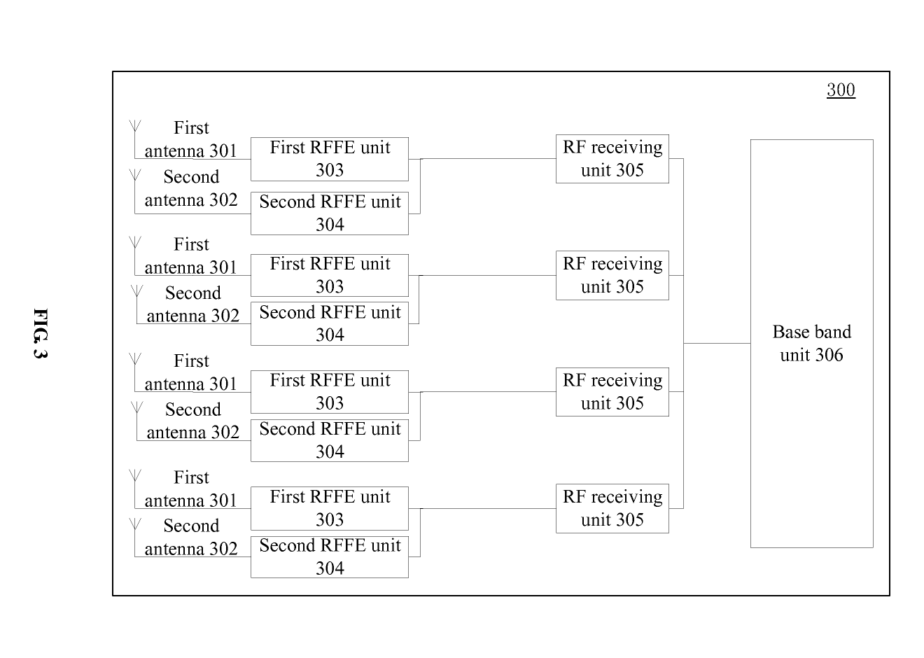

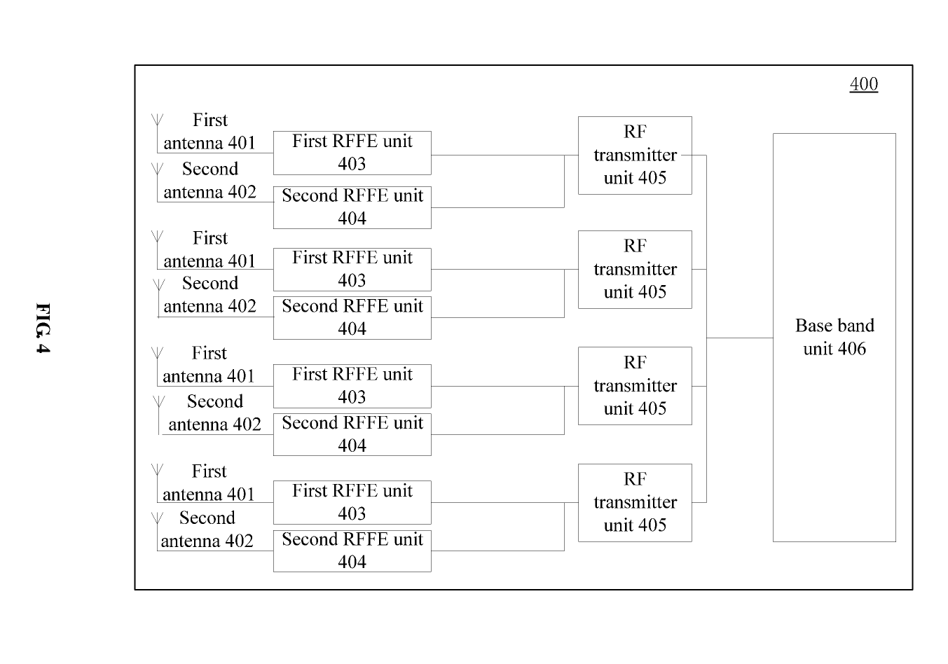

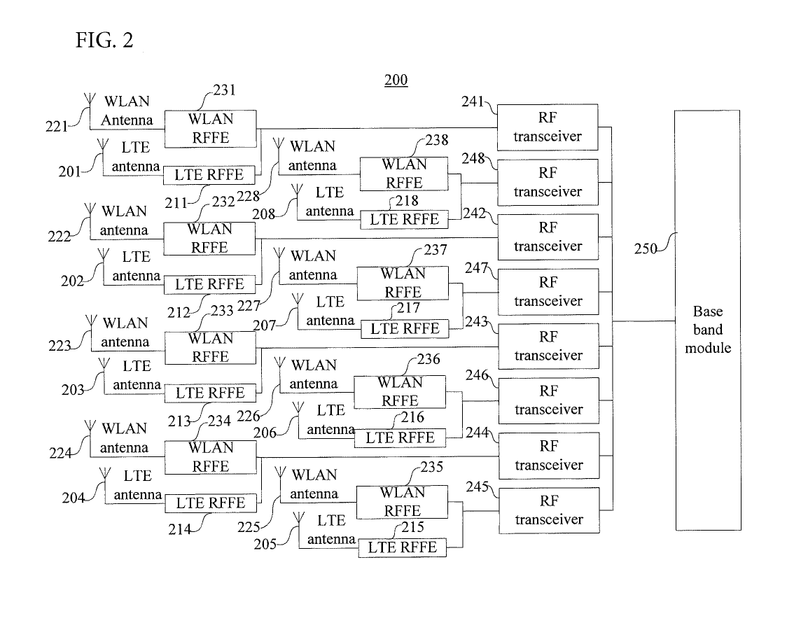

FIG. 2 schematically illustrates a circuit structure of a MIMO system 200 according to one embodiment.

In the embodiment illustrated in FIG. 2, the MIMO system 200 is configured as a 8*8 system and can support two communication modes, i.e., WLAN and LTE. It should be noted that the two communication modes are merely examples which can be implemented by the MIMO system 200. Besides, in some embodiments, the MIMO system 200 may be configured as a 1*1 SISO, 2*2, 4*4, or 16*16 MIMO system.

The MIMO system 200 includes 8 LTE antennas 201, 202, 203, 204, 205, 206, 207 and 208, which are respectively coupled to 8 LTE RFFE units 211, 212, 213, 214, 215, 216, 217 and 208. The MIMO system 200 further includes 8 WLAN antennas 221, 222, 223, 224, 225, 226, 227 and 228, which are respectively coupled to 8 WLAN RFFE units 231, 232, 233, 234, 235, 236, 237 and 238. The LTE antennas and the LTE RFFE units are adapted to transmitting and receiving signals in LTE mode, while the WLAN antennas and the WLAN RFFE units are adapted to transmitting and receiving signals in WLAN mode. The MIMO system 200 further includes 8 RF transceiver units 241, 242, 243, 244, 245, 246, 247 and 248 which are coupled to a base band unit 250. Besides, the 8 RF transceiver units are respectively coupled to the 8 LTE RFFE units, and also respectively coupled to the 8 WLAN RFFE units. That is to say, each RF transceiver unit is coupled to a pair of RFFE units including one LTE RFFE unit and one WLAN RFFE unit. Further, each RF transceiver unit is capable of processing OFDM signals.

The MIMO system 200 illustrated in FIG. 2 may be used to implement the MIMO communication method illustrated in FIG. 1, which will be described in detail hereinafter.

In step S101, a first antenna receives a first RF signal in a first communication mode.

Specifically, for the MIMO system 200, the first communication mode may be either LTE mode or WLAN mode. Accordingly, the first antenna may be either a LTE antenna or a WLAN antenna for receiving its corresponding signal. Hereunder, the first communication mode will be described as LTE mode, the first antenna will be described as a LTE antenna for communicating LTE signals, and the first RF signal in the first communication mode will be described as a LTE signal. Specifically, the first antenna will be described as the LTE antenna 201.

It should be noted that, in some embodiments, the first communication mode may be WLAN mode, the first antenna may be a WLAN antenna, and the first RF signal in the first communication mode may be a WLAN signal. Further, in some embodiments, if the MIMO system can support other communication mode, the first communication mode may alter.

In step S103, a first Radio Frequency Front End (RFFE) unit preprocesses the first RF signal in the first communication mode.

The first RFFE unit is coupled to the first antenna, such that it can receive and preprocess the LTE signal. In some embodiments, the preprocessing may include implementing low noise amplification and filtering to the LTE signal, so as to filter out interferer received with the LTE signal.

Referring to FIG. 2, it could be understood that the first RFFE unit is the LTE RFFE unit 211 coupled to the LTE antenna 201, and adapted to preprocessing the LTE signal. The WLAN RFFE unit 231 coupled to the WLAN antenna 221 may be referred to as a second RFFE unit for preprocessing a WLAN signal, if a WLAN signal comes in.

In step S105, a RF transceiver unit implements a first RF processing to the first RF signal which has been preprocessed to obtain a first base band signal.

Specifically, the RF transceiver unit 241 may implement the first RF processing to the LTE signal which has been preprocessed to obtain the first base band signal. In some embodiments, the first RF processing may include frequency conversion to convert the preprocessed LTE signal, which normally has a high frequency, into a mid-low frequency signal.

The RF transceiver unit 241 may also implement the first RF processing to signals in other communication mode, i.e., to WLAN signals. In some embodiments, to signals in different communication modes, the RF transceiver unit 241 may implement processing with different magnifications.

In step S107, a base band unit implements a first base band processing to the first base band signal to obtain identifiable information.

Specifically, the base band unit 250 may implement the first base band processing to the first base band signal. In some embodiments, the first base band processing may include AD conversion demodulation, and decoding. In some embodiments, the identifiable information may include information contained in the first base band signal, i.e., information contained in the LTE signal received by the LTE antenna 201.

In step S109, the base band unit transmits a control signal to the first RFFE unit based on the identifiable information.

Specifically, the identifiable information may include type of the received signal in the first communication mode. Based on the type information contained in the identifiable information, the base band unit can transmit the control signal to a RFFE corresponding to the type. In the specific example, the base band unit 250 may transmit the control signal to the LTE RFFE unit 211. In subsequent processing, in some embodiments, the control signal may be used to control the LTE RFFE 211 to process a signal obtained from a second RF processing.

In step S111, the base band unit implements a second base band processing to obtain a second base band signal.

In the specific example, the base band unit 250 may implement the second base band processing. In some embodiments, the second base band processing may include performing coding modulation and DA conversion, to the first base band signal, to obtain the second base band signal with mid-low frequency.

In step S113, the RF transceiver unit implements a second RF processing to the second base band signal to obtain a second RF signal.

In some embodiments, the RF transceiver unit 241 may implement the second RF processing, including frequency conversion, to the second base band signal. Such that the second base band signal with mid-low frequency may be converted to a second RF signal with high frequency.

In some embodiments, to signals in different communication modes, the RF transceiver unit 241 may implement processing with different magnifications.

In step S115, the first RFFE unit post processes the second RF signal based on the control signal to obtain a transmitting RF signal.

Specifically, according to the control signal, the MIMO system 200 can use a RFFE unit corresponding to the second RF signal which has been processed by the RF transceiver unit 241, i.e., the LTE RFFE unit 211, to implement the post processing. In such a way, the transmitting radio frequency signal can be generated, and it shall be a LTE signal.

In step S117, the first antenna sending the transmitting radio frequency signal.

In the specific example, the LTE antenna 201 may send the LTE signal.

Referring still to FIG. 2, in some embodiments, the MIMO system 200 may receive one or more WLAN signal and one or more LTE signals at the same time. In such an occasion, the WLAN RFFE units and the LTE RFFE units, which shall be units coupled to different RF transceiver units in corresponding branches at the same time, may receive the WLAN signals and the LTE signals, respectively. After preprocessing the received WLAN signals and the received LTE signals, the WLAN RFFE units and the LTE RFFE units may send these signals to the RF transceiver units in which RF processing may be implemented to convert these RF signals with high frequencies to base band signals with mid-low frequencies. Note that for each branch, it could be working under one specific communication mode at one time cycle. However, different branches can work under different communication modes at the same time. For example, the WLAN antenna 221 may receive a first WLAN signal and transmit it to the WLAN RFFE unit 231. The RF transceiver unit 241 may implement RF processing to the first WLAN signal. At the same time, the LTE antenna 202 may receive a first LTE signal and transmit it to the LTE EFFE unit 212. The RF transceiver unit 242 may implement RF processing to the first LTE signal. After the RF processing, the RF transceiver units 241 and 242 may send the first WLAN signal and the first LTE signal to the base band unit 250. The base band unit 250 may perform base band processing to the first WLAN signal and the first LTE signal, respectively, to obtain the identifiable information contained therein. Since the identifiable information contained in the first WLAN signal and the first LTE signal can indicate their types, the base band unit 250 is able to identify the first WLAN signal and the first LTE signal. In such a way, the MIMO system 200 can be used to simultaneously communicate signals in different communication modes.

If there are a LTE signal plus a WLAN signal to be transmitted in a same RF transceiver route, interference may occur. Therefore, in some embodiments, within one time cycle, there is only one signal in one communication mode allowed being transmitted in one RF transceiver route. For example, the base band unit 250 may transmit a control signal to the LTE RFFE unit 211 or the WLAN RFFE unit 231, so as to control them to process a corresponding LTE signal or WLAN signal. In such a way, when the base band unit 250 transmits the control signal to the LTE RFFE unit 211, the LTE RFFE unit 211 can start operating to process the corresponding LTE signal transmitted from the RF transceiver unit 241. When the base band unit 250 transmits the control signal to the WLAN RFFE unit 231, the WLAN RFFE unit 231 can state operating to process the corresponding WLAN signal transmitted from the RF transceiver unit 241. That is to say, there is only one signal in one communication mode transmitted in the RF transceiver route within one time cycle, which can be controlled by the base band unit 250.

In some embodiments, the MIMO system 200 may initiate a WLAN service and a LTE service, spontaneously. Specifically, the process may include: a base band unit generating an instruction which include send a WLAN signal or a LTE signal; the base band unit generating a control signal based on the instruction and transmitting the control signal to a corresponding WLAN RFFE unit or LTE RFFE unit, where the control signal is used for controlling the WLAN RFFE unit or the LTE RFFE unit to post process a RF signal transmitted from a RF transceiver unit which is coupled to both the WLAN RFFE unit and the LTE RFFE unit; the WLAN RFFE unit or the LTE RFFE unit post processing the RF signal transmitted from the RF transceiver unit based on the control signal; and a WLAN antenna coupled to the WLAN RFFE unit transmitting the signal which has been post processed, or a LTE antenna coupled to the LTE RFFE unit transmitting the signal which has been post processed.

In some embodiments, the MIMO system 200 may be used as a WIFI hotspot and also used for processing LTE service. Referring to FIG. 2, in such occasion, the base band unit 250 may use the RF transceiver units 241, 242, 243, 244, 245, 246, 247 and 248 based on practical requirements. The base band unit 250 may transmit a control signal to the LTE RFFE unit in one branch, and transmit a control signal to the WLAN RFFE unit in another branch. Therefore, one branch can be used to transmit and receive a LTE signal, while another branch can be used to transmit and receive a WLAN signal.

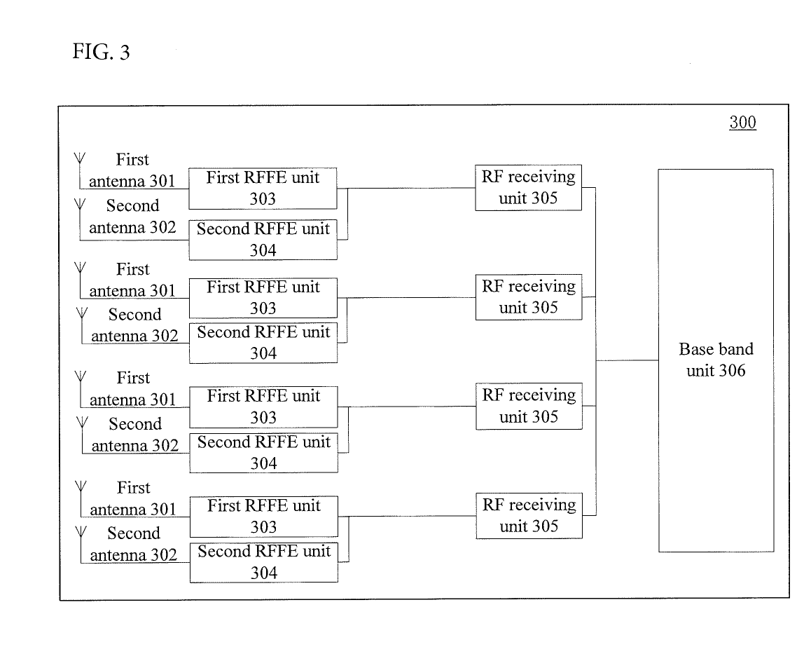

According to one embodiment, a MIMO system 300 is provided. Referring to FIG. 3, the MIMO system 300 includes:
a plurality of first antennas 301, adapted for receiving signals in a first communication mode;
a plurality of second antennas 302, adapted for receiving signals in a second communication mode;
a plurality of first RFFE units 303, each of which is coupled to one of the first antennas 301 and adapted for preprocessing the signal in the first communication mode to obtain a first RF signal;
a plurality of second RFFE units 304, each of which is coupled to one of the second antennas 302 and adapted for preprocessing the signal in the second communication mode to obtain a second RF signal; and
a plurality of RF receiving units 305, each of which is coupled to one of the first antennas 301 and one of the second antennas 302, and adapted for implementing RF processing to the first RF signal and the second RF signal.

In some embodiments, the first communication mode is LTE mode, and the second communication mode is WLAN mode.

In some embodiments, the preprocessing includes low noise amplification and filtering.

In some embodiments, the MIMO system 300 further includes a base band unit 306 for implementing base band processing to the signal which has been subjected to the RF processing.

In some embodiments, the MIMO system 300 includes 2 sets of first antennas 301 and 2 sets of second antennas 302, or 4 sets of first antennas 301 and 4 sets of second antennas 302, or 8 sets of first antennas 301 and 8 sets of second antennas 302, or 16 sets of first antennas 301 and 16 sets of second antennas 302. The number of the first RFFE units 303 is the same as the number of the first antennas 301. The number of the second RFFE units 304 is the same as the number of the second antennas 302.

In some embodiments, the MIMO system 300 is used in a mobile terminal, such as a mobile phone.

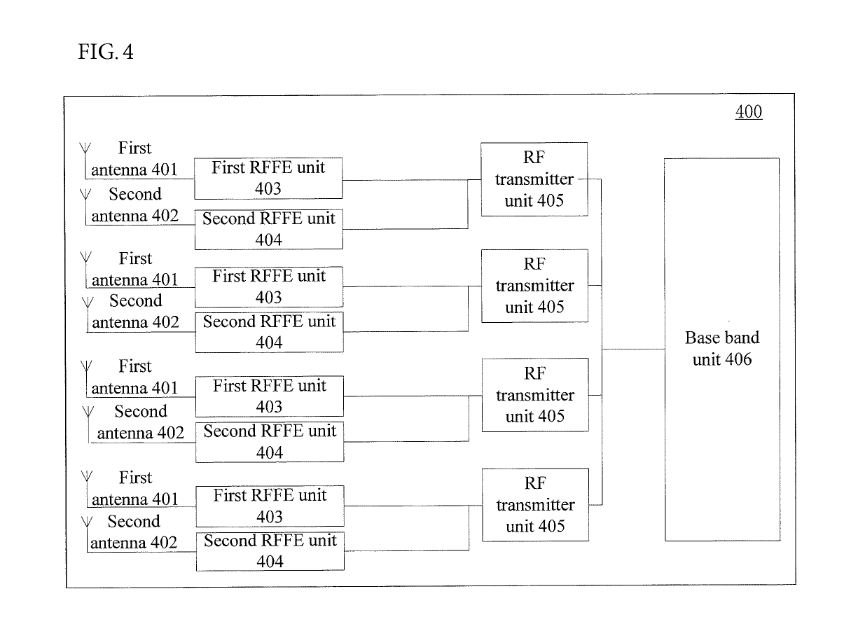

According to one embodiment, a MIMO system 400 is provided. Referring to FIG. 4, the MIMO system 400 includes a plurality of first antennas 401, a plurality of second antennas 402, a plurality of first RFFE units 403, a plurality of second RFFE units 404, a plurality of RF transmitter units 405 and a base band unit 406. The base band unit 406 is coupled to a plurality of branches each of which comprises one of the RF transceiver units, one of the first antennas, one of the second antennas, one of the first RFFE units and one of the second RFFE units.

For one branch, the base band unit 406 is adapted for transmitting a control signal to the first RFFE unit 403 or the second RFFE unit 404, to control the first RFFE unit 403 or the second RFFE unit 404 to post process a RF signal transmitted from the corresponding RF transceiver unit 405. The RF transceiver unit 405 is coupled to the base band unit 406 and is adapted for processing a base band signal transmitted from the base band unit 406 to obtain the RF signal. The first RFFE unit 403 is coupled to the RF transceiver unit 405 and adapted for implementing a first processing to the RF signal based on the control signal to obtain a first transmitting signal. The second RFFE unit 404 is coupled to the RF transceiver unit 405 and adapted for implementing a second processing to the RF signal based on the control signal to obtain a second transmitting signal. The first antenna 401 is coupled to the first RFFE unit 403 and adapted for transmitting the first transmitting signal. The second antenna 402 is coupled to the second RFFE unit 404 and adapted for transmitting the second transmitting signal.

In some embodiments, the first transmitting signal is a WLAN signal, and the second transmitting signal is a LTE signal.

In some embodiments, the base band unit 406 is further adapted for: implementing base band processing to a signal received by the first antenna 201 or the second antenna 202 to obtain information contained in the signal; and obtaining the control signal based on the information contained in the signal.

In some embodiments, the base band unit 406 is further adapted for: generating an instruction which includes transmitting a WLAN signal or a LTE signal; and generating the control signal based on the instruction.

Based on the above, in embodiments of the present disclosure, each one RF transceiver unit is used to transmit and receive signals in two communication modes, such that the number of the RF transceiver units in the MIMO system can be reduced, which means less system resource will be occupied. Based on the control signal transmitted from the base band unit, a suitable RFFE unit can be selected to process to a WLAN signal or a LTE signal. Then a suitable antenna can be selected to transmitting or receiving the corresponding signal. Therefore, interference raised by communicating signals in two different communication modes in the same RF transceiver route can be avoided.

The disclosure is disclosed, but not limited, by preferred embodiments as above. Based on the disclosure of the disclosure, those skilled in the art can make any variation and modification without departing from the scope of the disclosure. Therefore, any simple modification, variation and polishing based on the embodiments described herein is within the scope of the present disclosure.

What is claimed is:

1. A MIMO (multi-input multi-output) communication method, comprising:
a base band unit sending a control signal to a first RFFE (radio frequency front end) unit or a second RFFE unit, where the control signal is used to control the first RFFE unit or the second RFFE unit to implement post processing to a RF (radio frequency) signal transmitted from a RF transmitter unit which is coupled to both the first RFFE unit and the second RFFE unit;
based on the control signal, the first RFFE unit or the second RFFE unit implementing the post processing to the RF signal transmitted from the RF transmitter unit; and
a first antenna coupled to the first RFFE unit or a second antenna coupled to the second RFFE unit transmitting the RF signal which has been subjected to the post processing.

2. The MIMO communication method according to claim 1, wherein the first RFFE unit is a RFFE unit for processing WLAN (wireless local area network) signals, and the second RFFE unit is a RFFE unit for processing LTE (long term evolution) signals.

3. The MIMO communication method according to claim 2, wherein the method further comprises: processing a signal received by the first antenna or the second antenna to obtain information contained in the signal; and generating the control signal based on the information contained in the signal.

4. The MIMO communication method according to claim 2, wherein the control signal is generated based on an instruction generated by the base band unit, and the instruction comprises transmitting a WLAN signal or transmitting a LTE signal.

5. A MIMO (multi-input multi-output) communication method, comprising:
using a first antenna to receive a signal in a first communication mode;
using a second antenna to receive a signal in a second communication mode;
using a first RFFE (radio frequency front end) unit to preprocess the signal in the first communication mode to obtain a first RF (radio frequency) signal;
using a second RFFE unit to preprocess the signal in the second communication mode to obtain a second RF signal; and
using a single RF receiving unit to implement RF processing to both the first RF signal and the second RF signal.

6. The MIMO communication method according to claim 5, wherein the first communication mode is WLAN (wireless local area network) mode, and the second communication mode is LTE (long term evolution) mode.

7. A MIMO (multi-input multi-output) system, comprising a base band unit, a RF (radio frequency) transmitter unit, a first RFFE (radio frequency front end) unit, a second RFFE unit, a first antenna, and a second antenna,
wherein the base band unit is adapted for sending a control signal to the first RFFE unit or the second RFFE unit, where the control signal is used to control the first RFFE unit or the second RFFE unit to implement a post processing to a RF signal transmitted from the RF transmitter unit,
wherein the RF transmitter unit is coupled to the base band unit and adapted for processing a base band signal transmitted from the base band unit to obtain the RF signal,
wherein the first RFFE unit is coupled to the RF transmitter unit and adapted for implementing a first post processing to the RF signal based on the control signal to obtain a first transmitting signal,
wherein the second RFFE unit is coupled to the RF transmitter unit and adapted for implementing a second post processing to the RF signal based on the control signal to obtain a second transmitting signal,
wherein the first antenna is coupled to the first RFFE unit and adapted for transmitting the first transmitting signal, and
wherein the second antenna is coupled to the second RFFE unit and adapted for transmitting the second transmitting signal.

8. The MIMO system according to claim 7, wherein the first transmitting signal is a WLAN (wireless local area network) signal, and the second transmitting signal is a LTE (long term evolution) signal.

9. The MIMO system according to claim 8, wherein the base band unit is further adapted for:
processing a signal received by the first antenna or the second antenna to obtain information contained in the signal; and
generating the control signal based on the information contained in the signal.

10. The MIMO system according to claim 8, wherein the base band unit is further adapted for:
generating an instruction which comprises transmitting a WLAN signal or transmitting a LTE signal; and
generating the control signal based on the instruction.

11. A MIMO (multi-input multi-output) system, comprising:
a first antenna adapted for receiving a signal in a first communication mode;
a second antenna adapted for receiving a signal in a second communication mode;
a first RFFE (radio frequency front end) unit, coupled to the first antenna and adapted for preprocessing the signal in the first communication mode to obtain a first RF (radio frequency) signal;
a second RFFE unit, coupled to the second antenna and adapted for preprocessing the signal in the second communication mode to obtain a second RF signal; and
a RF receiving unit, coupled to both the first RFFE unit and the second RFFE unit, and adapted for implementing RF processing to both the first RF signal and the second RF signal.

12. The MIMO system according to claim 11, wherein the first communication mode is WLAN (wireless local area network) mode, and the second communication mode is LTE (long term evolution) mode.
